(19) United States
(12) Patent Application Publication
(10) Pub. No.: US 2025/0353218 A1
(43) Pub. Date: Nov. 20, 2025

(54) SOLVENT-BASED PLASTIC RECYCLING METHOD TO REMOVE INKS AND PRODUCE CLEAR FILMS

(71) Applicant: Wisconsin Alumni Research Foundation, Madison, WI (US)

(72) Inventors: George Huber, Middleton, WI (US); Tianwei Yan, Madison, WI (US); Charles Granger, Madison, WI (US); Kevin Sanchez-Rivera, Madison, WI (US); Reid Van Lehn, Madison, WI (US); Ezra Bar-Ziv, Madison, WI (US); Fei Long, Madison, WI (US); Panzheng Zhou, Madison, WI (US)

(73) Assignee: Wisconsin Alumni Research Foundation, Madison, WI (US)

(21) Appl. No.: 18/665,208

(22) Filed: May 15, 2024

(51) Int. Cl. B29B 17/02; B29K 105/00; B29K 105/26; C08J 11/02; C08J 11/08; C09D 9/00

(52) U.S. Cl. CPC B29B 17/02; C08J 11/02; C08J 11/08; C09D 9/005; B29B 2017/0293; B29K 2105/0032; B29K 2105/26

(57) ABSTRACT

A solvent-based plastic recycling method that removes color and produces plastic polymers substantially free of exogenous colorants. The method comprises selecting a solvent that selectively dissolves an individual polymer and has low solubility of colorants and decomposition products of the colorants. A combined precipitator and piston device is used to precipitate the polymer solution and mechanically remove the solvent from the precipitate before thermal drying. An adsorption bed is used to clean the recovered solvent as it is recycled to the process.

### BACKGROUND

A large share of the plastic packaging materials made and used today are composite plastics made of multiple different layers. The combination of several layers of different materials improves the mechanical and physical properties of the plastic. For example, ethylene vinyl alcohol (EVOH) is commonly added to improve the oxygen barrier properties of the plastic. Current strategies to recycle plastic packaging materials rely on mechanical separations to bin plastic materials by type, to allow for them to be melted down and pelletized. These methods are incompatible with layered composite films because melting them down in bulk recombines all the layers into a mixture that does not share the same bulk properties as the original material. Catalytic methods have been used to decompose polymeric materials into their original monomers. However, these strategies often require stoichiometric amounts of reagents, which is expensive and wasteful. Pyrolysis technologies have been proposed whereby composite films are decomposed at high temperatures in the absence of oxygen to form liquid fuel precursors. However, these technologies typically suffer from low yields, and require harsh process conditions.

Another challenge in plastic recycling lies in the removal of contaminants, especially coloring agents. Yellow color is especially difficult to remove from plastics. Colored plastics often require additional sorting and processing steps compared to clear plastics. Colorants are often deeply embedded within the plastic matrix, making them resistant to traditional cleaning and separation methods. Additionally, different types of pigments may require specific treatment approaches, further complicating the process. Without color removal, recycled plastics may have diminished structural integrity and aesthetic appeal, limiting their applications and economic viability.

A process called solvent targeted recovery and precipitation (STRAP) has been developed for recovering components of printed multilayer plastic films or mixed plastic waste, which uses selective dissolution of the individual plastic components guided by thermodynamic calculations of polymer solubility. In the present disclosure, new innovations are developed to enhance the solvent-based plastic recycling process, focusing on removal of coloring agents and solvent recycling.

### SUMMARY

Disclosed and claimed herein is a method for recovering an individual polymer and removing color from a plastic waste, the method comprising:
(a) selectively dissolving the polymer in a solvent to yield a polymer solution, wherein the solvent has low solubility of the colorants and decomposition products of the colorants;
(b) separating the polymer solution from the undissolved plastic waste by mechanical filtration;
(c) precipitating the polymer and removing the solvent before drying; and
(d) cleaning the removed solvent with an adsorbent for reuse.

The coloring agents in the plastic waste may comprise one or more pigments, such as azo pigments, arylide pigments, diarylide pigments, isoindolinone pigments, phthalocyanine pigments, dioxazine pigments, quinacridone pigments, and their decomposition products during manufacturing and recycling.

Various thermodynamic methods can be used to guide the solvent selection, including Hansen Solubility Parameters (HSP), Hildebrand solubility parameters, Kamlet-Taft parameters, Flory-Huggins theory, COSMO-RS calculation, etc. For example, the ratio of polymer-solvent distance (Rₐ) and polymer interaction radius (R₀) for a HSP calculation should be less than 1 for the solvent and the colorant.

Exemplary, non-limiting solvents may comprise linear or cyclic C6-C20 alkanes, methanol, dichloromethane, ethylene glycol, acetone, isopropanol, 1-propanol, toluene, chloroform, tetrahydrofuran, tetrahydropyran, triethylamine, 1,2-propanediol, dimethyl sulfoxide, acetylacetone, tert-butanol, formic acid, xylenes, etc.

In some versions, the method comprises dissolving the polymer in the solvent at an elevated temperature in step (a), and precipitating the polymer by lowering the temperature in step (c). The “elevated temperature” as used herein refers to a temperature that is higher than room temperature at which the polymer is dissolved in the solvent. For instance, the elevated temperature is about 50-200° C.

In step (a), the solvent to plastic ratio is preferably more than 5:1.

Step (c) can be conducted in a combined precipitator and piston press device, the device comprising:
a precipitator configured to precipitate the polymer from the polymer solution to form a slurry;
a first valve at the bottom of the precipitator to seal the precipitator during precipitation;
a mechanical piston within the precipitator configured to compresses the slurry after precipitation to yield a compressed polymer cake;
a filter below the first valve to allow outflow of the solvent, but not the precipitated polymer during compression;
a second valve below the filter that opens after compression; and an auger configured to break up the compressed polymer cake and transport it to the next process step.

The precipitator is a vertical, jacketed, and cooled column. Preferably, the column has a length to diameter ratio of at least 10:1. The first and the second valves can each be a knife edge valve. The filter is a porous, cylindrical filter. The filter is washed using hot solvent between cycles to prevent blockage.

It is shown that removing solvent before drying reduces color in the plastic product. In step (c), the solvent can be removed by various methods, including, but not limited to, piston press, filter press, dewatering screw, and dewatering centrifuge.

In step (d), the adsorbent is selected from the group consisting of activated carbon, silica, alumina, molecular sieves, zeolites, and diatomaceous earth. The removed solvent can be cleaned by passing through an adsorption bed comprising a packed adsorbent column. The adsorption bed further comprises a porous, cylindrical filter to allow outflow of the solvent, but not solid adsorbent particles.

The objects and advantages of the disclosure will appear more fully from the following detailed description of the preferred embodiment of the disclosure made in conjunction with the accompanying drawings.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 shows a general flow diagram of the method disclosed herein. Each number represents a specific stream of the process. Critical steps are highlighted by squares, including solvent selection; precipitation and compression along with solvent removal; and solvent cleaning.

FIG. 2 shows an exemplary solvent selection using HSP calculations for solvents that selectively dissolve PE but have low solubility of PU ink binders.

FIG. 3 compares colors of recycled plastic products from a feedstock using toluene, heptane, and dodecane as solvents.

FIG. 4 shows chemical structures of pigments commonly used in plastics, including Yellow 1, Orange 13, Yellow 12, Violet 23, Green 7, Blue 15:3, Red 52:1, Violet 19, and Yellow 110.

FIG. 5 shows dissolution of pigments in dodecane at various conditions. 1: Pure dodecane; 2: Orange 13; 3: Yellow 12; 4: Green 7; 5: Blue 15:3; 6: Violet 23; 7: Red 52:1; 8: Yellow 1; 9: Violet 19; 10: Yellow 110. Tests 1-6, 9, 10 were heated in 120° C. dodecane, cooled to room temperature and filtered. Test 7 was heated in 120° C. dodecane and cooled to room temperature. Test 8 was in dodecane at room temperature.

FIG. 6 shows potential decomposition pathways of Yellow 12 and Orange 13.

FIG. 7 compares light absorbance profiles of post-STRAP solvents under different conditions, heated Yellow 12 in dodecane, Yellow 1 in dodecane at room temperature, and Yellow 12 in toluene at room temperature.

FIG. 8 shows chemical formula and COSMO screening charge density profiles of Yellow 12 and Yellow 1 pigments.

FIGS. 9A-9B show dissolution of Yellow 12 (FIG. 9A) and Yellow 1 (FIG. 9B) in dodecane and toluene at room temperature or heated to 120° C. then cooled to room temperature.

FIG. 10 shows light absorbance profiles of pigments in dodecane, heptane, and cyclohexane heated to 110° C.

FIGS. 11A-11B show the impact of solvent to solids ratios on colors in recycled plastic products. FIG. 11A shows the yellowness index of three STRAP process products (“a,” “b,” and “c”) using different solvent to plastic ratios. The corresponding solvent to plastic ratios are shown in FIG. 11B.

FIG. 12A shows an exemplary configuration of the precipitator and piston press device disclosed herein. This design includes a cooling system, a nitrogen system, and hot/cold solution circulation system. FIG. 21B depicts an exemplary precipitator and piston press that can be used in the method. FIG. 12C depicts a cross-sectional view through line A-A of the exemplary precipitator and piston press shown in FIG. 12B.

FIG. 13 shows an experimental vessel for testing the effectiveness of piston compression.

FIG. 14 shows dryness of polymer cake represented by the percentage of solvent in the compressed filter cake (Y-axis) as a function of applied pressure by the piston (X-axis) for recovering LDPE with solvent to solids ratios of 10:1, 13:1, and 16.5:1.

FIG. 15 shows a workflow of evaluating the effect of removing solvent before drying on color reduction in recycled plastic product.

FIGS. 16A-16B show yellowness index of recycled plastic product as a function of percentage of solvent in filter cake (FIG. 16A) and liquid to solids ratio (FIG. 16B) before drying.

FIG. 17 shows yellowness index of recycled plastic product as a function of pigment concentration in dried PE from filter cakes with different percentage of solids.

FIG. 18 shows adsorption of Yellow 12 (PY12) from a dodecane solution using activated carbon (upper panel) and colors of dodecanes after adsorption, post-STRAP dodecanes, and pure dodecane (lower panel).

FIGS. 19A-19B show isotherm (FIG. 19A) and kinetics (FIG. 19B) of activated carbon as an adsorbent for cleaning recycled solvents. FIG. 19B shows kinetics of activated carbon with different particle sizes and loading. With particle size <100 μm, the adsorption was too fast to track the kinetics.

FIG. 20 shows an exemplary adsorption bed for cleaning recycled solvents as disclosed herein.

FIG. 21A is a photograph showing the results of an exemplary hot absorption experiment for removing pigments from hot polymer solution using the present method: polyethylene (“PE”) precipitation with the AC treatment (left) and without (right). FIG. 21B is a histogram showing the yellowness index (“YI”) and light absorbance of the vacuum-dried samples.

### DETAILED DESCRIPTION

### Definitions and Abbreviations

AC=activated carbon; COSMO-RS=Conductor-like screening model for realistic solvents; EVOH=Ethylene vinyl alcohol; HSP=Hansen Solubility parameter; LDPE=Low-density polyethylene; PE=Polyethylene; PU=Polyurethane; STRAP=Solvent targeted recovery and precipitation.

Numerical ranges as used herein are intended to include every number and subset of numbers contained within that range, whether specifically disclosed or not. Further, these numerical ranges should be construed as providing support for a claim directed to any number or subset of numbers in that range. For example, a disclosure of from 1 to 10 should be construed as supporting a range of from 2 to 8, from 3 to 7, from 5 to 6, from 1 to 9, from 3.6 to 4.6, from 3.5 to 9.9, and so forth.

As used herein, the singular forms “a,” “an,” and “the” include plural referents unless the content clearly dictates otherwise.

As used herein, the term “or” is an inclusive “or” operator and is equivalent to the term “and/or” unless the context clearly dictates otherwise.

As used herein, the term “about” refers to ±10% of the variable referenced.

The phrase “mechanical filtration” is defined broadly herein to encompass any mechanical filtration mechanism, method, or device, now known or developed in the future. The phrase includes passing a solution/mixture containing liquid and solid components through a physical barrier, such as a mesh or porous material, to trap and remove solid particles and suspended materials. Thus, “mechanical filtration” encompasses filtration of any and all description, including filtration accomplished gravitationally or with added pressure (and/or vacuum) to draw liquid material through the physical barrier, cross-flow filtration, etc. “Mechanical filtration” also includes centrifugation (with or without filters, sedimentation centrifuges, continuous or batch, etc.), rotary and conveyor dryers, cyclones, and the like.

The elements and method steps described herein can be used in any combination whether explicitly described or not, unless otherwise specified or clearly implied to the contrary by the context in which the referenced combination is made.

All combinations of method steps as used herein can be performed in any order, unless otherwise specified or clearly implied to the contrary by the context in which the referenced combination is made.

The systems and methods of the present disclosure can comprise, consist of, or consist essentially of the essential elements and limitations described herein, as well as any additional or optional components, or limitations described herein or otherwise useful in the art. The disclosure provided herein suitably may be practiced in the absence of any element which is not specifically disclosed herein.

It is understood that the disclosure is not confined to the particular elements and method steps herein illustrated and described, but embraces such modified forms thereof as come within the scope of the claims.

### General Flow

Provided herein is a novel method to remove color, including yellow, from plastics recycled via dissolution. The method allows for production of colorless recycled plastic, which has increased market demand over colored recycled plastics.

A number of solvent-based plastic recycling methods have been developed, including the process of solvent targeted recovery and precipitation (STRAP) to deconstruct multilayer plastic films or mixed plastic waste. The general principle underlying the STRAP process is to selectively dissolve a single polymer component in a solvent system in which the targeted polymer component is soluble, but the other polymer components are not. The solubilized polymer component is then separated from the multilayer film or mixed plastic waste by filtration and precipitated. The solvents are recovered and reused. The targeted polymer component is recovered as a dry, pure solid resin. This process is repeated for each of the polymer components in the multilayer film or mixed plastic waste, resulting in several segregated streams that can then be recycled. The STRAP process and systems carrying out the process are described in US 2023/0174736 A1 and WO 2024/044529 A1, the entirety of which are incorporated herein by reference.

One of the unanswered challenges of the STRAP process lies in the removal of contaminants, especially coloring agents. The present disclosure addresses the unmet need and provides novel methods to enhance color removal and solvent recycling in solvent-based plastic recycling processes.

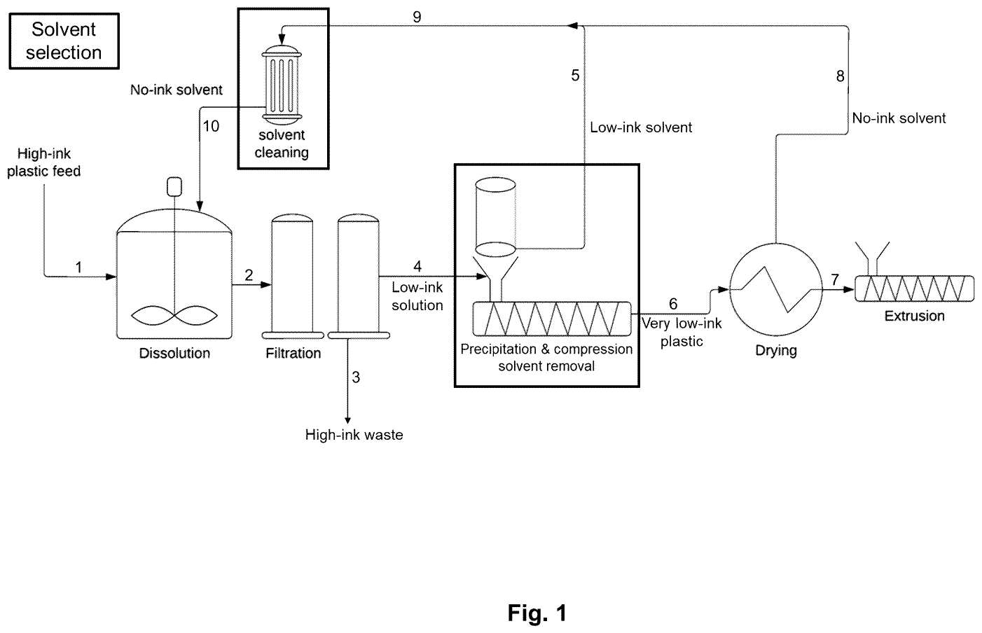

A general flow of the method disclosed herein is shown in FIG. 1. The first step is to select a solvent that selectively dissolves a target polymer component of the plastic waste and has low solubility of colorants and decomposition products of the colorants. The plastic waste is then fed into a dissolution vessel (stream 1) to dissolve the target polymer in the solvent. The resulting mixture (stream 2) is filtered by mechanical filtration to separate the undissolved plastic waste (stream 3) from the polymer solution. The polymer solution (stream 4) subsequently goes through a precipitation and compression process in a uniquely designed precipitator and piston-press device to precipitate the dissolved polymer and remove the solvent. The resulting polymer (stream 6) is then dried and extruded (steam 7) to yield recycled plastic resin pellets. Solvents removed from the precipitation process (stream 5) and drying process (stream 8) are combined (stream 9) and go through a solvent cleaning process to produce clean solvents (stream 10) for reuse.

Table 1 shows a projected mass balance of the method, determined by empirical models. The stream numbers in the table correspond to the stream numbers shown in FIG. 1. As shown in the table, the method effectively recovered the target polymer, with 6062.5 kg/h in the dried product (stream 7) out of 6250 kg/h after dissolution (stream 2). The dried product (stream 7) contains only trace amount (0.25 kg/h) of nontargeted polymers. Colorants of the plastic waste were effectively removed. The amount of colorants dropped from 200 kg/h in stream 2 to 0.02 kg/h after filtration (stream 4), indicating that the majority of the colorants were not dissolved in the selective solvent. The subsequent precipitation and compression further removed colorants, resulting in 1.44×10⁻³ kg/h colorants in the product (streams 6 and 7). The solvent removed from the precipitation and drying processes contained 0.0186 kg/s colorants (stream 9) and was completely removed by the solvent cleaning process for reuse (stream 10).

TABLE 1
Results of an exemplary operation of the method.

| | Target Polymer | Other polymers | Colorants | Solvent |
|---|---|---|---|---|
| Stream | (kg/h) | (kg/h) | (kg/h) | (kg/h) |
| 2 | 6250 | 2500 | 200 | 89500 |
| 4 | 6062.5 | 0.25 | 0.02 | 86800.27 |
| 5 | 0 | 0 | 1.86E−02 | 8.07E+04 |
| 6 | 6062.5 | 0.25 | 1.40E−03 | 6.06E+03 |
| 7 | 6062.5 | 0.25 | 1.40E−03 | 0 |
| 8 | 0 | 0 | 0 | 6.06E+03 |
| 9 | 0 | 0 | 1.86E−02 | 89500 |
| 10 | 0 | 0 | 0 | 89500 |

The critical and innovative steps of the method disclosed herein include solvent selection, precipitation and compression along with solvent removal, and solvent cleaning (highlighted by the squares in FIG. 1), which are described below in detail.

### Solvent Selection

Solvents can be selected to avoid dissolution of coloring agents to reduce color in the recycled plastic product.

The selective solvents used in the method can be any common industrial solvents, including, but not limited to, toluene, dodecane, heptane, cyclohexane, o-xylene, p-xylene, benzene, n-butanol, dimethylformamide (DMF), tetrahydrofurfuryl alcohol, dimethyl sulfoxide (DMSO), tetrahydrofuran (THF), tetrahydropyran (THP), N-methyl-2-pyrrolidnone (NMP), γ-valerolactone (GVL), acetone, 1-propanol, 1,2-propanediol, isopropyl alcohol (IPA), methanol, water, formic acid, furfural, acetonitrile, 1,4-dioxane, cyrene, and dihydropyran.

Various thermodynamic methods can be used to guide the solvent selection, including, but not limited to, calculation of Hansen Solubility parameters (HSPs), Hildebrand solubility parameters, Kamlet-Taft solvent parameters, Gutmann-Beckett solvent parameters, Swain-Lupton solvent parameters, Flory-Huggins interaction parameters, molecular dynamics simulations, and a combined quantum chemical and statistical mechanical approach called the conductor-like screening model for realistic solvents (COSMO-RS). The methods have been previously described. See e.g., Walker et al. “Recycling of multilayer plastic packaging materials by solvent-targeted recovery and precipitation.” Sci. Adv. 2020, 6(47): eaba7599; Sánchez-Rivera et al. “Reducing Antisolvent Use in the STRAP Process by Enabling a Temperature-Controlled Polymer Dissolution and Precipitation for the Recycling of Multilayer Plastic Films.” ChemSusChem 2021, 14(19): 4317-4329; Lin and Nash. “An Experimental Method for Determining the Hildebrand Solubility Parameter of Organic Nonelectrolytes.” J. Pharm. Sci. 1993, 82(10): 1018-1026; Tadros, T. (2013). Flory-Huggins Interaction Parameter. In: Tadros, T. (eds) Encyclopedia of Colloid and Interface Science. Springer, Berlin, Heidelberg.

The solubility of a polymer can be characterized by three HSPs that quantify the strength of dispersion interactions (δ_{D})), dipole-dipole interactions (δ_{P}), and hydrogen bonding interactions (δ_{H}) between solvent and polymer molecules. These three parameters are used as coordinates that locate the compounds in HSP space. Each polymer has an additional radius parameter, R₀, that defines a sphere in HSP space. HSPs (and values of R₀) for a wide range of pure solvents and polymers have been tabulated based on empirical measurements to obtain self-consistent values (S. Abbott, C. M. Hansen, Hansen Solubility Parameters in Practice (2008); Hansen-Solubility.com). HSPs for solvents are estimated as functions of their measured enthalpies of vaporization. HSPs for polymers are determined by experimentally quantifying polymer solubility in reference solvent systems that span HSP space and by identifying a spherical subspace centered on the HSPs of the polymer such that solvents that promote polymer dissolution fall within the sphere. Ro therefore depends on the polymer's solubility in the reference solvent systems.

“Good” solvents (those that promote polymer dissolution at the desired concentration) that are not included in the reference set can then be identified by calculating the geometric distance (Ra) between HSP values for the solvent (solv) and polymer (polym) in δ_{D}−δ_{P}−δ_{H} space using Equation 1:

$${R}_{a} = \sqrt{4 {( {δ}_{D}^{solv} - {δ}_{D}^{polym} )}^{2} + {( {δ}_{P}^{solv} - {δ}_{P}^{polym} )}^{2} + {( {δ}_{H}^{solv} - {δ}_{H}^{polym} )}^{2}} \qquad ( Equation 1 )$$

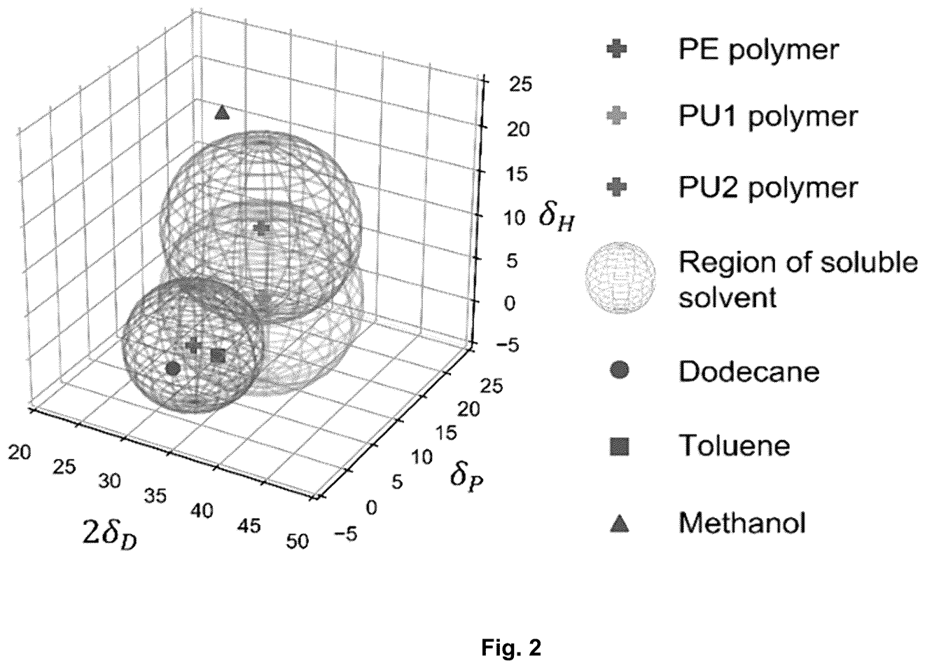

Good solvents are defined as those that fall within the solubility sphere for the corresponding polymer (See FIG. 2 as an example) or equivalently when the ratio Rₐ/R₀ is less than one (1). HSP calculations can thus select good solvents that selectively dissolve the target polymer (with Rₐ/R₀<1) with low solubility of colorants (with Rₐ/R₀>1) using only a small number of experiments.

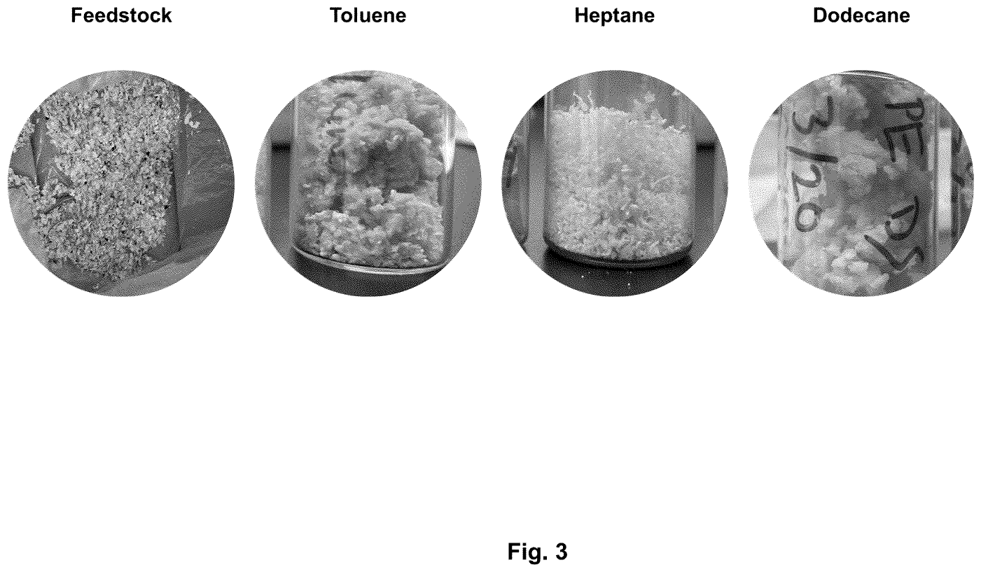

Table 2 shows an exemplary HSP calculation for determining conditions in which dissolution is preferential for the target polymers PE and EVOH and not the PU ink binders. Rₐ/R₀ values for 11 PU resins were calculated, and the values less than 1 are highlighted in bold in Table 2. Among the PE-selective solvents (toluene, dodecane, heptane, and diphenyl ether), dodecane and heptane are preferably to be used in the disclosed method, as the Rₐ/R₀ values are all >1 for the 11 PU resins in dodecane and heptane, indicating low solubility of the ink binders in the solvents. The PU resins also have low solubility in the EVOH-selective DMSO/water mixture, with Rₐ/R₀ values>1 for all the 11 PU resins. A test was conducted using toluene, heptane, and dodecane as the solvent to recover PE polymer from a feedstock. As shown in FIG. 3, polymers recovered using heptane and dodecane exhibited clear color, while polymers recovered using toluene exhibited a yellow color. The result is consistent with the prediction of the HSP calculations.

TABLE 2
HSP calculations for PE and EVOH selective solvents and 11 PU resins.

| | | | | | EVOH-selective |
|---|---|---|---|---|---|
| | PE-selective | | | | DMSO/water |
| | Toluene | Dodecane | Heptane | Diphenyl ether | mixture |
| Rₐ/R₀ for 11 | 0.85 | 1.15 | 1.21 | 0.71 | 3.09 |
| PU | 2.13 | 3.22 | 3.48 | 2.02 | 11.60 |
| | 1.40 | 1.69 | 1.73 | 1.07 | 2.39 |
| | 1.70 | 2.11 | 2.18 | 1.24 | 3.07 |
| | 1.10 | 1.33 | 1.37 | 0.83 | 1.41 |
| | 1.26 | 1.40 | 1.41 | 1.11 | 2.14 |
| | 0.97 | 1.28 | 1.34 | 0.59 | 1.90 |
| | 0.79 | 1.19 | 1.28 | 0.43 | 3.01 |
| | 1.11 | 1.45 | 1.51 | 0.88 | 3.47 |
| | 1.40 | 1.81 | 1.88 | 0.95 | 3.04 |
| | 0.89 | 1.30 | 1.39 | 0.50 | 3.01 |

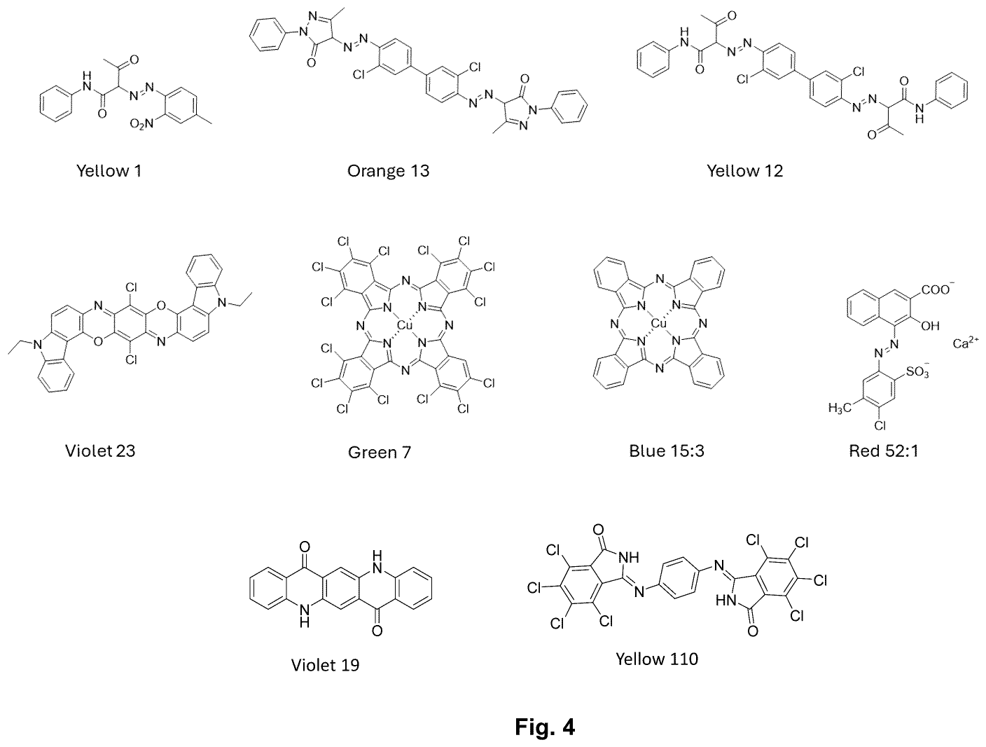

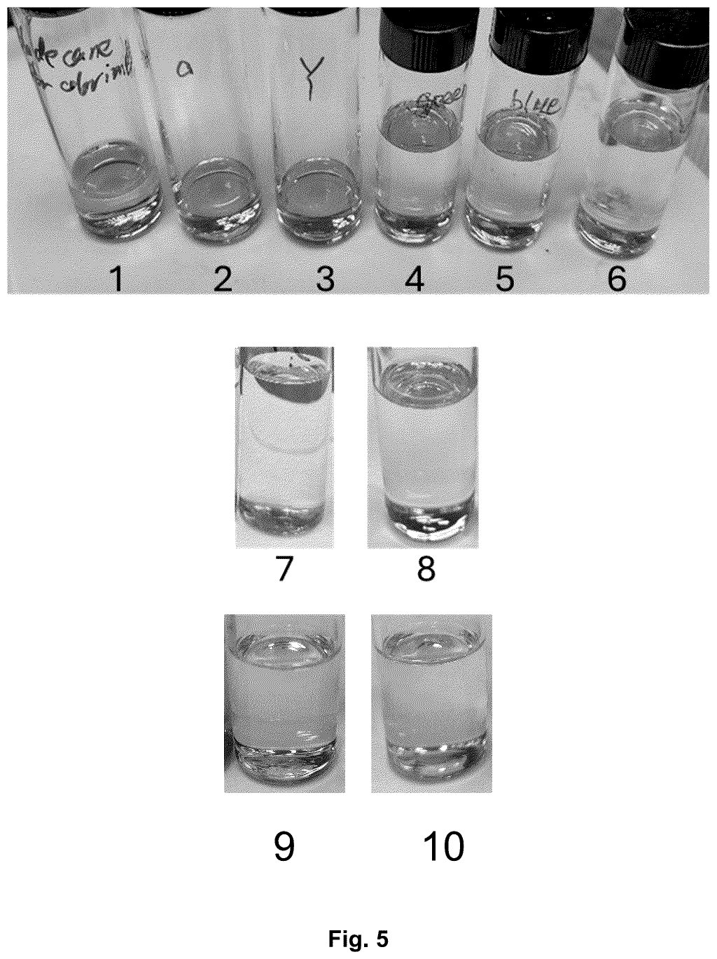

Other than binders, pigments can also dissolve in the solvents of the STRAP process. FIG. 4 shows chemical structures of common pigments in plastic waste. The pigments have different solubility at different conditions. As shown in FIG. 5, Yellow 1 dissolves in dodecane at room temperature (number 8). Orange 13 and Yellow 12 dissolve at high temperature (120° C.) and do not precipitate after cooling to room temperature (numbers 2 and 3). Violet 23 slightly dissolves at high temperature (120° C.; number 6). The rest of the pigments do not dissolve in dodecane at high temperature (numbers 4, 5, and 7), and thus do not contribute to coloring of the recycled plastic product.

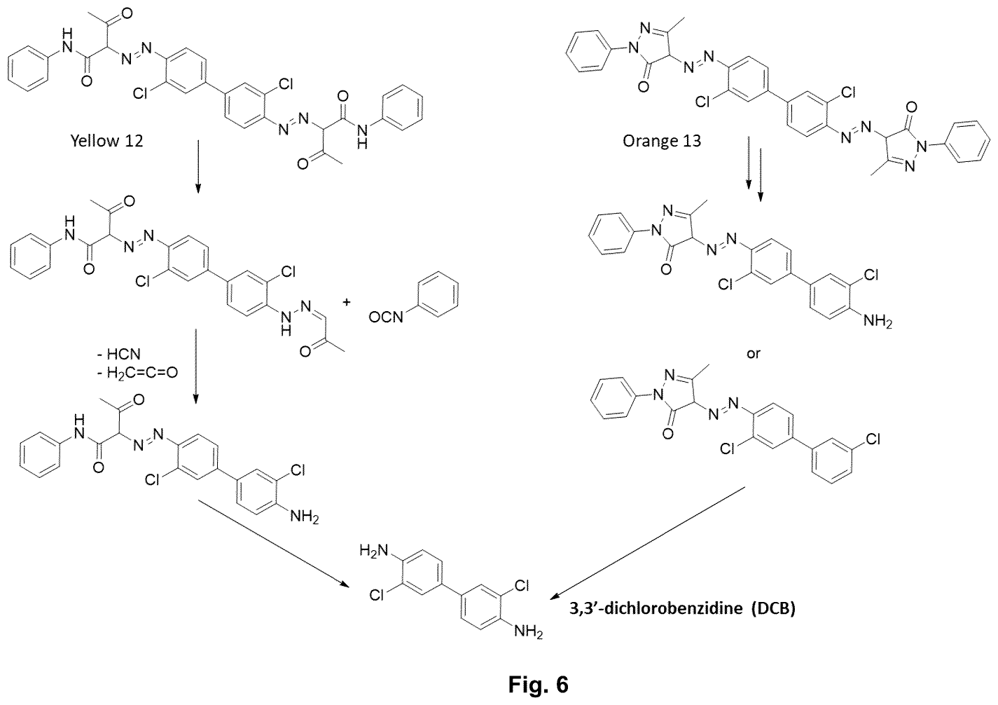

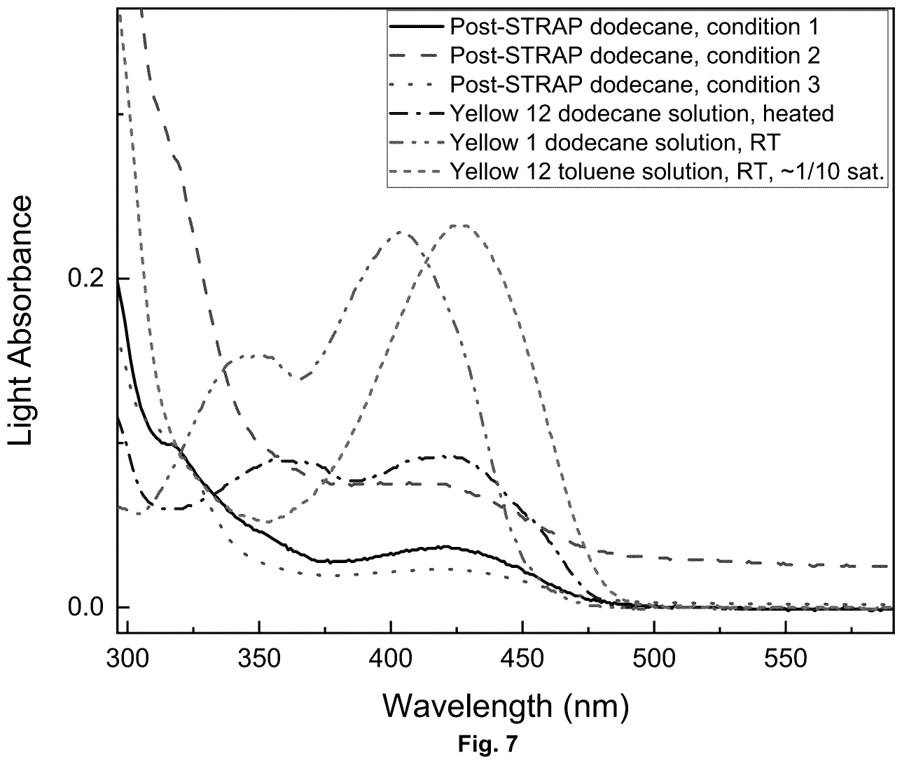

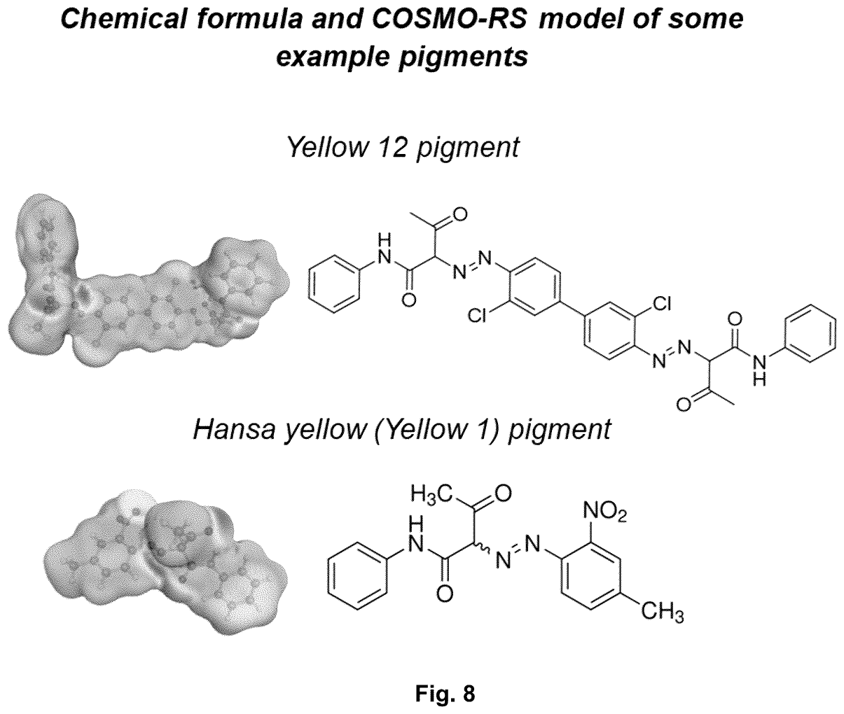

Investigation of the STRAP process found that yellow colors pass through the filtration step. Sources of the yellow colors were examined. It is found that the colored components from printed film samples do not dissolve in dodecane at room temperature. Thus, arylide yellow pigments (Yellow 1 & analogs) were excluded as the source of yellow color passing through the filtration process, as Yellow 1 dissolves in dodecane at room temperature (FIG. 5). Diarylide yellow pigments (Yellow 12 & analogs) do not dissolve in alkane solvents at room temperature, but dissolve at high temperature and do not precipitate after cooling to room temperature (as shown in FIG. 5, number 3). The finding is consistent with the finding that yellow colors pass through the filtration step of the STRAP process. The process likely involves thermal decomposition and coloring decomposition products. FIG. 6 shows potential decomposition pathways of Yellow 12 and Orange 13 (Az et al. “Pigment decomposition in polymers in applications at elevated temperatures.” Dyes and Pigments 1991, 15(1): 1-14). FIG. 7 compares light absorbance profiles of post-STRAP solvents, heated Yellow 12 in dodecane, Yellow 1 in dodecane at room temperature, and heated Yellow 12 in toluene. The heated Yellow 12 in dodecane shows a different shape and peak position from Yellow 12 in toluene at room temperature. The peak position of the heated Yellow 12 in dodecane matches with that of the post-STRAP solvent. The peak shape is close to that of the (mono) arylide Yellow 1, but with red shift. According to the results, the colorant in STRAP process is likely the (mono) arylide decomposed from diarylide yellow pigments (Yellow 12 & analogs).

The solvent can be selected to minimize colorant dissolution using COSMO-RS. COSMO-RS enables predictions of polymer solubility as a function of both the temperature and the liquid phase composition using the conformations from molecular dynamics (MD) simulations. MD simulations provide detailed calculations of polymer structures and conformations. COSMO-RS combines unimolecular density functional theory calculations with statistical thermodynamics methods to account for molecular interactions, thus enabling a priori predictions of polymer solubility in solvent mixtures as a function of both the temperature and the composition of the liquid phase (A. Klamt. “Conductor-like screening model for real solvents: A new approach to the quantitative calculation of solvation phenomena.” J. Phys. Chem. 1995, 99:2224-2235; A. Klamt et al. “Refinement and parametrization of COSMO-RS.” J. Phys. Chem. A 1998, 102:5074-5085; Walker et al. “Recycling of multilayer plastic packaging materials by solvent-targeted recovery and precipitation.” Sci. Adv. 2020, 6(47): eaba7599).

COSMO-RS enables computational prediction of pigment solubility and partition coefficients in different systems to guide solvent selection and method design of colorant removal. The prediction method includes using a quantitative structure-activity relationship model to estimate the Gibbs free energy of fusion of the pigments and uses experimental solubility values reported in the literature to calibrate the model (OECD Existing Chemicals Database. “Pigment yellow 12 assessment profile” SIDS Initial Assessment Meeting. 2003). Alternatively, model predictions can be calibrated using measured experimental values. Table 3 shows exemplary solubility prediction results for 3 pigments in dodecane and other solvents. FIG. 7 shows exemplary chemical formula and COSMO-RS model of Yellow 12 and Yellow 1 pigments.

TABLE 3
Example solubility prediction results for 3 pigments
in selected solvents at two temperatures per solvent.

| | pigment | | | | | |
|---|---|---|---|---|---|---|
| | | | Yellow 12 | | | |
| | Yellow 12 | | decomposition | | Hansa yellow | |
| Solvent | pigment | | products | | (Yellow 1) | |
| Dodecane at 25° C. | 1.33 | μg/L | 11.6 | μg/L | 8.4 | g/L |
| Dodecane at 120° C. | 0.63 | mg/L | 2.45 | mg/L | 68.3 | g/L |
| Toluene at 25° C. | 3.89 | mg/L | 4.07 | mg/L | 636 | g/L |
| Toluene at 110° C. | 0.14 | g/L | 0.12 | g/L | 695 | g/L |
| Ethanol at 25° C. | 2.79 | mg/L | 2.33 | mg/L | 222 | g/L |
| Ethanol at 77° C. | 10.02 | mg/L | 34.64 | mg/L | 605 | g/L |

| | | | | | |
|---|---|---|---|---|---|
| DMSO at 25° C. | 1.05 | g/L | 2.96 | g/L | Miscible |
| DMSO at 120° C. | 3.81 | g/L | 5.09 | g/L | Miscible |

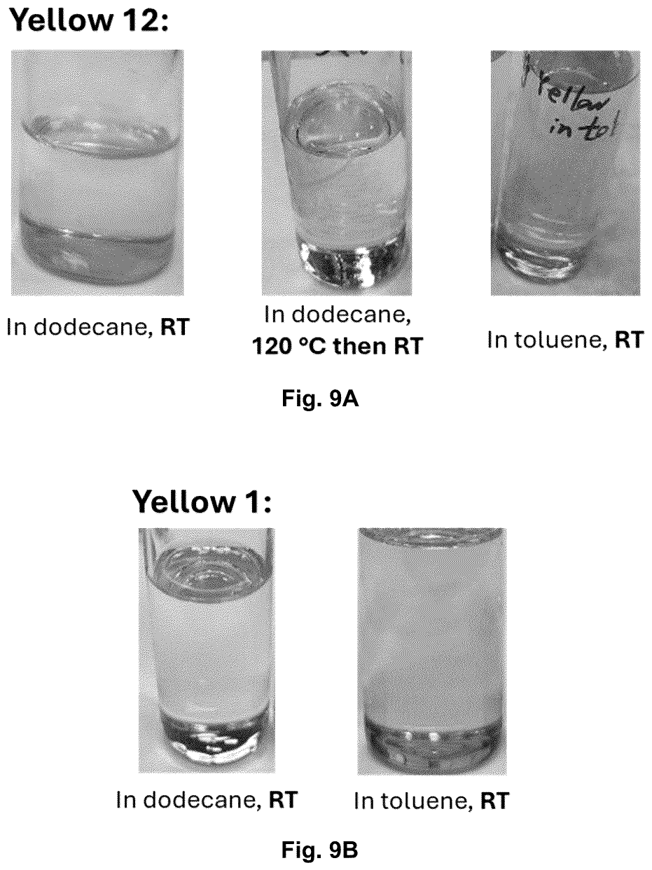

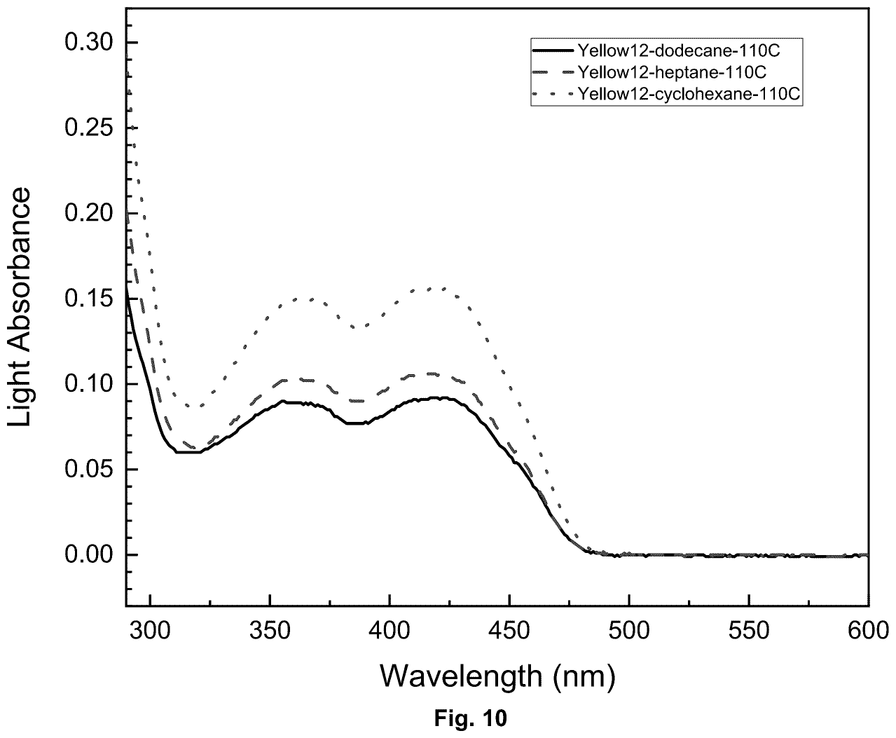

By considering ink pigment compounds in solvent selection, alkanes show lower solubility of ink pigments than aromatics. As shown in FIGS. 9A and 9B, Yellow 12 and Yellow 1 dissolve significantly more in toluene than in dodecane. Dissolution of the pigments in three alkanes (dodecane, heptane, and cyclohexane) were further compared at 110° C. and then cooled to room temperature (FIG. 10). Heptane dissolves slightly more pigments than dodecane, while cyclohexane dissolves significantly more pigments than heptane and dodecane.

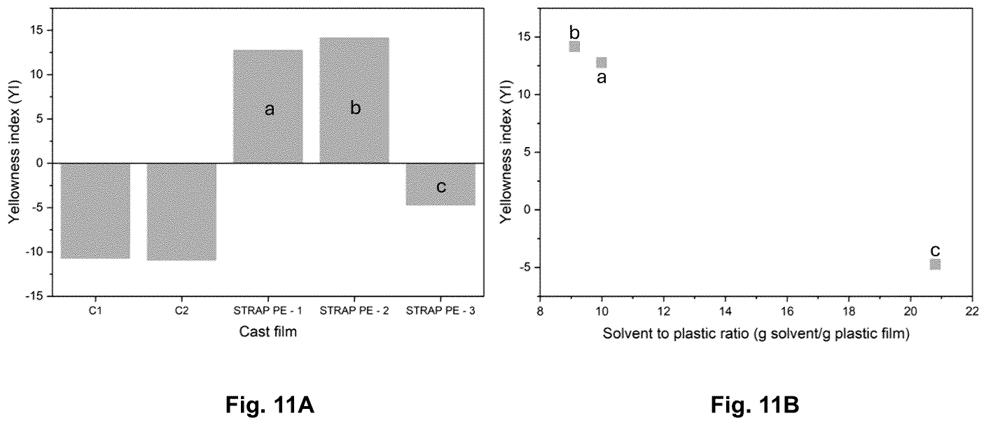

Additionally, process conditions can be adjusted to reduce color in product by reducing dissolution of colorants and decomposition of colorants. The process conditions include solvent to solids ratio, temperature, pressure, etc. For example, adjusting solvent to solids ratio is shown to enhance color reduction in the recycled plastic product. As shown in FIGS. 11A-11B, a solvent to plastic ratio of about 21 (test “c”) yielded product with significantly lower yellowness index, compared to solvent to plastic ratios less than 10 (tests “a” and “b”).

### Precipitation and Compression

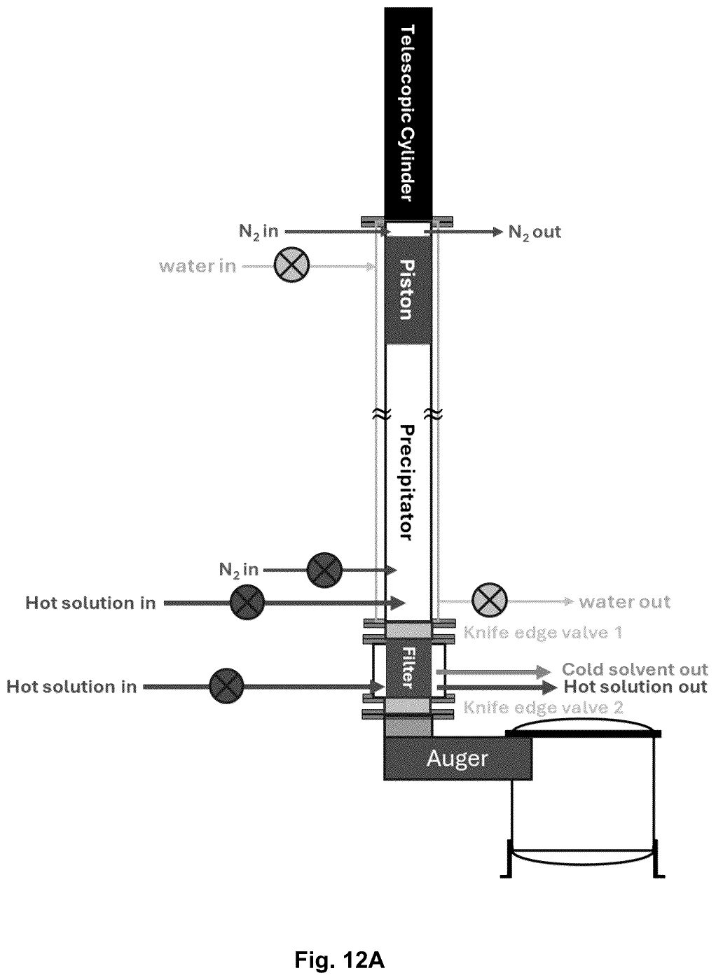

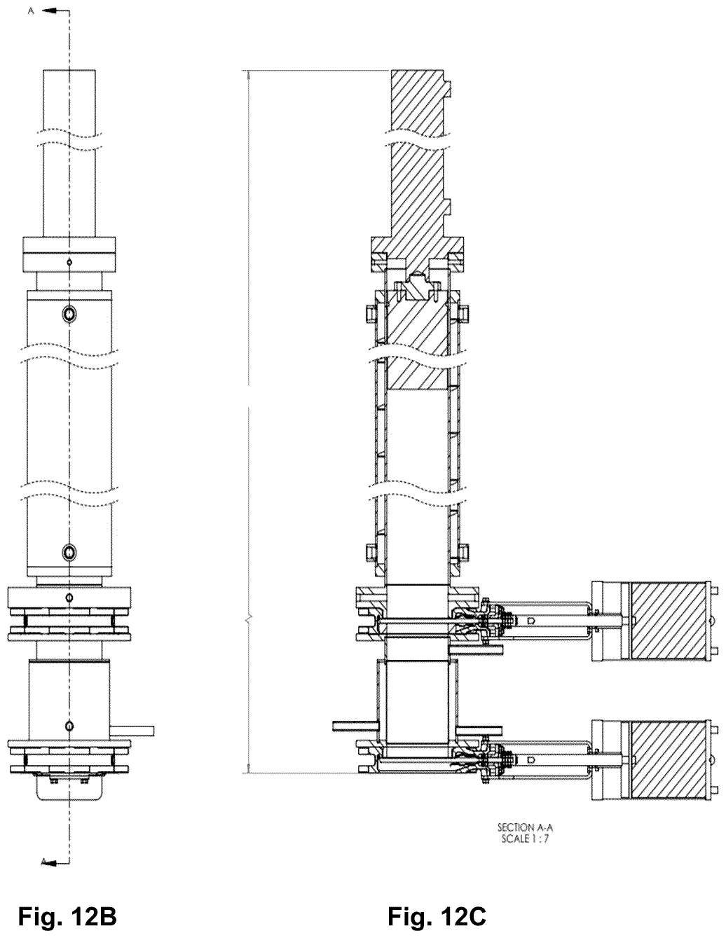

A combined precipitator and piston-press device can be used to facilitate precipitation of the polymer and deliquoring of the polymer solvent slurries. As shown in FIG. 12, the device comprises:
A vertical, jacketed, and cooled column (precipitator) for precipitation of solvent-polymer solutions without mixing;
A first retractable plate or valve at the bottom of the column that is closed to seal the column during precipitation and opens to allow flow of solvent during compression. The retractable plate or valve can be a knife edge valve;
A mechanical piston located in the column that compresses the slurry after precipitation. The internal piston mechanism is used to apply compressive force to the precipitate within the column, removing solvent and colorants from the precipitated polymer. In an exemplary embodiment, the piston can generate pressure of about 0-40 bar;
A porous, cylindrical filter below the first retractable plate or valve to allow outflow of solvent, but not solid polymer, during compression;
A second retractable plate or valve below the filter that opens after compression; and
An auger or screw conveyor to break up compressed polymer cake and transport it to the next process step.

The precipitator preferably has a high length to diameter (L/D) ratio to encourage more conduction over convection heat transfer, minimizing material flow. For example, the L/D ratio of the precipitator can be about 13:1. In some embodiments, the L/D ratio of the precipitator is at least 10:1. Specific configuration and dimension of the device is not limited to the exemplary device shown herein.

In one operation cycle, the hot polymer-solvent solution is precipitated in the column typically cooled by circulating water (see the arrows indicating “water in” and “water out” in FIG. 12). During precipitation, the knife edge valve 1 is closed. After precipitation, the knife edge valve 1 is open and the piston is pressed to apply compressive force to the slurry such that the solvent passes through the filter and is removed (see the arrow indicating “cold solvent out” in FIG. 12). Then the knife edge valve 2 is open and the compressed polymer cake is fed to the auger to break up the compressed polymer cake and transport it to the next step. The porous filter is flushed with hot solvent between cycles to prevent blockages (see the arrows indicating “hot solution in” and “hot solution out” in FIG. 12).

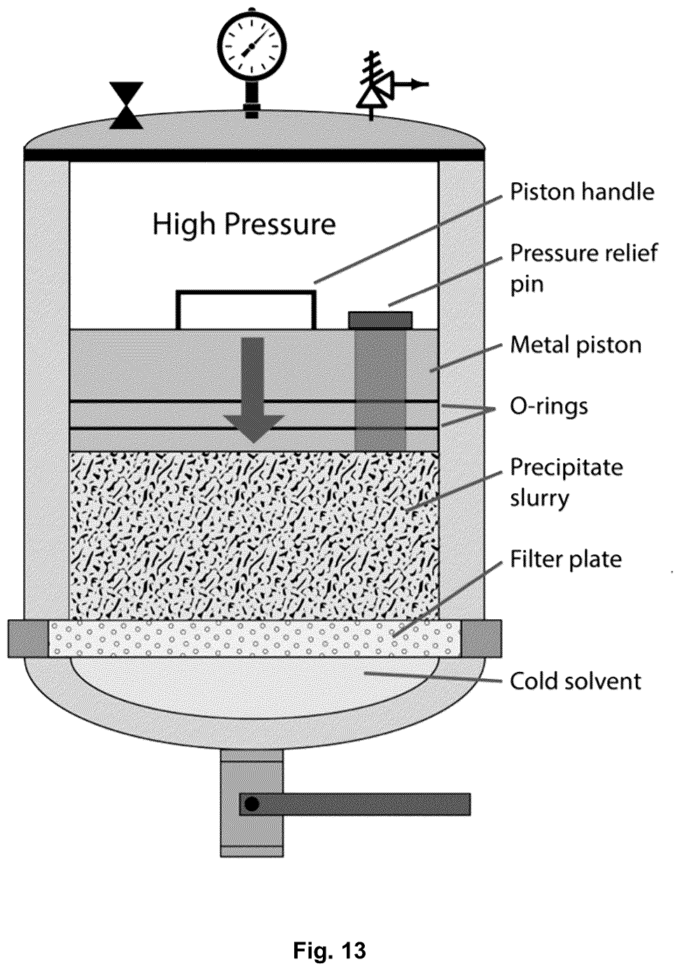

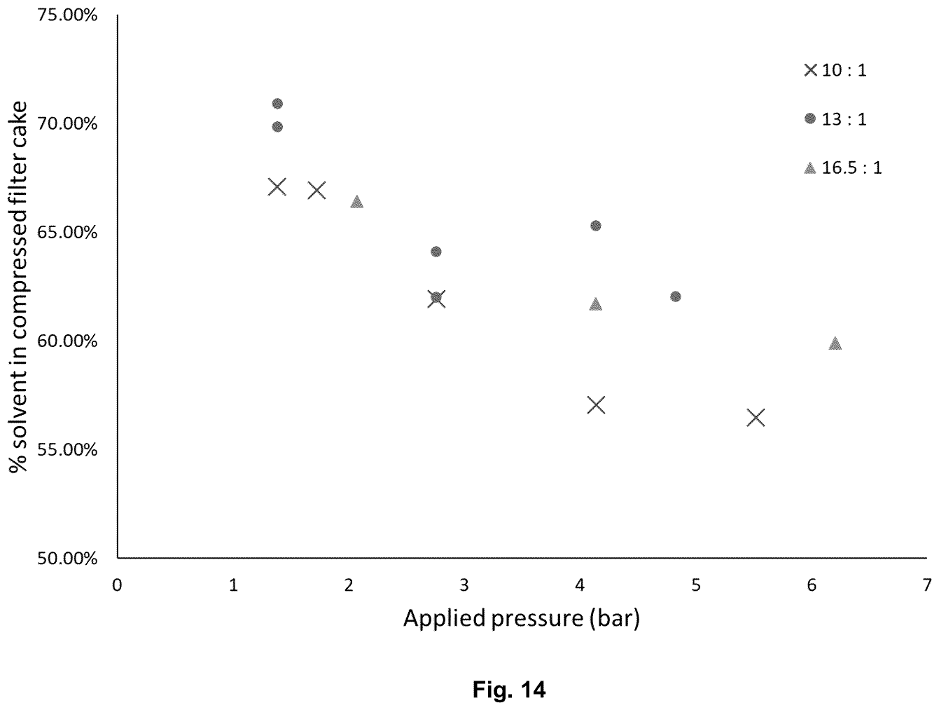

The design of the combined precipitator and piston device was initially tested by laboratory experiments using the setup as shown in FIG. 13. The device is a vessel comprising a metal piston above the precipitate slurry and a 1 μm filer plate below the precipitate slurry. The pressure within the vessel was monitored when the piston is pressed to apply compressive force to the precipitate slurry. As shown in Table 4 and FIG. 14, the percentage of solvent in the compressed filter cake decreased, as the applied pressure by the piston increased, indicating effective removal of the solvent by the piston compression. Additionally, piston compression is shown to be more effective than vacuum (Table 5).

TABLE 4
Polymer cake dryness versus pressure (LDPE).

| | | | | | | | |
|---|---|---|---|---|---|---|---|
| | P | P | Time | cake | solids | % | % |
| Solvent | (psi) | (bar) | (s) | mass | mass | solids | solvent |

Solvent:solids = 13:1

| | | | | | | | |
|---|---|---|---|---|---|---|---|
| dodecane | 20 | 1.38 | 135 | 233.66 | 67.95 | 29.08% | 70.92% |
| dodecane | 20 | 1.38 | 107 | 237.13 | 71.51 | 30.16% | 69.84% |
| dodecane | 40 | 2.76 | 93 | 136.65 | 51.9 | 37.98% | 62.02% |
| dodecane | 40 | 2.76 | 90 | 193.7 | 69.55 | 35.91% | 64.09% |
| dodecane | 60 | 4.14 | 102 | 104.35 | 36.22 | 34.71% | 65.29% |
| dodecane | 70 | 4.83 | 92 | 223.3 | 84.75 | 37.95% | 62.05% |

Solvent:solids = 10:1

| | | | | | | | |
|---|---|---|---|---|---|---|---|
| dodecane | 20 | 1.38 | 72 | 233.95 | 76.98 | 32.90% | 67.10% |
| dodecane | 25 | 1.72 | 75 | 236.12 | 78.1 | 33.08% | 66.92% |
| dodecane | 40 | 2.76 | 73 | 177.84 | 67.7 | 38.07% | 61.93% |
| dodecane | 60 | 4.14 | 94 | 219.67 | 94.32 | 42.94% | 57.06% |
| dodecane | 80 | 5.52 | 62 | 157.65 | 68.6 | 43.51% | 56.49% |

Solvent:solids = 16.5:1

| | | | | | | | |
|---|---|---|---|---|---|---|---|
| dodecane | 90 | 6.21 | 91 | 116.04 | 46.5 | 40.07% | 59.93% |
| dodecane | 60 | 4.14 | 102 | 127.7 | 48.9 | 38.29% | 61.71% |
| dodecane | 30 | 2.07 | 114 | 124.76 | 41.9 | 33.58% | 66.42% |

TABLE 5
Comparison of vacuum to piston compression.

| Deliquoring | Effective | Pre-oven | Post-oven | % Solids of | % Solvent |
|---|---|---|---|---|---|
| method | pressure (bar) | mass (g) | mass (g) | cake | in cake |
| vaccum | 1 | 85.28 | 14.39 | 16.87% | 83.13% |
| vaccum | 1 | 58.02 | 10.07 | 17.36% | 82.64% |
| vaccum | 1 | 143.35 | 23.44 | 16.35% | 83.65% |
| piston | 2.07 | 99.54 | 43.5 | 43.70% | 56.30% |
| piston | 2.07 | 110.77 | 49.4 | 44.60% | 55.40% |
| piston | 2.07 | 125.23 | 55.05 | 43.96% | 56.04% |

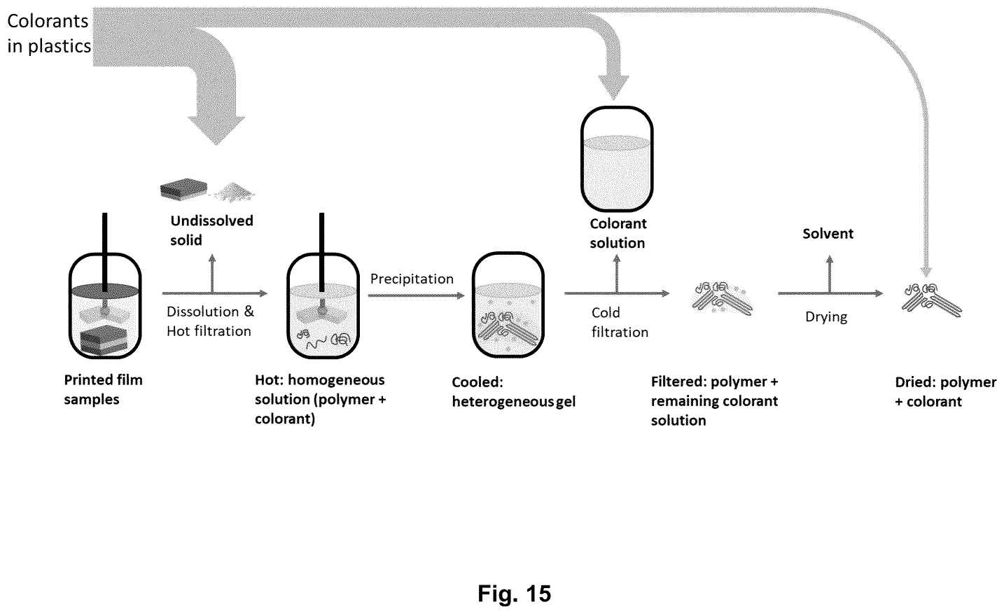

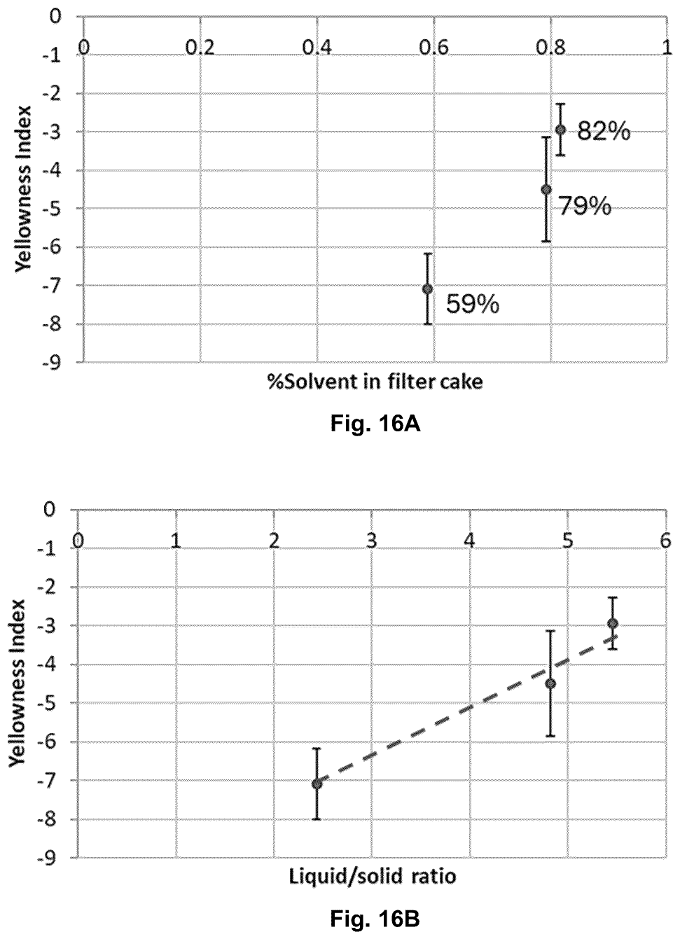

Deliquoring of solvent-polymer slurries before thermal drying can reduce the color of the recycled plastic product. The deliquoring methods that are suitable to use include, but are not limited to, piston presses, filter presses, dewatering screws, dewatering centrifuges, etc. An experiment was designed to compare yellowness of products with different residue solvent contents before drying (FIG. 15). LDPE was dissolved in a pigment solution in dodecane, and subsequently precipitated and compressed to yield polymer cakes with different residue solvent contents. The polymer cakes were then dried, and the yellowness of the products were tested. The results showed that removing solvent via compression significantly reduces the yellowness of the recycled plastic product (Table 6 and FIGS. 16A-16B).

TABLE 6
Yellowness index of dried products from polymer
cakes with different solid contents.

| Light abs of | Pre-oven | Post-oven | % solids | Yellowness |
|---|---|---|---|---|
| solution | mass (g) | mass (g) | of cake | Index* |
| 0.082 | 2.600 | 1.0670 | 41.04% | −7.09 |
| 0.082 | 4.916 | 1.0194 | 20.74% | −4.5 |
| 0.082 | 5.731 | 1.0500 | 18.32% | −2.94 |

*Yellowness index was measured by Kevin Nelson (Amcor).

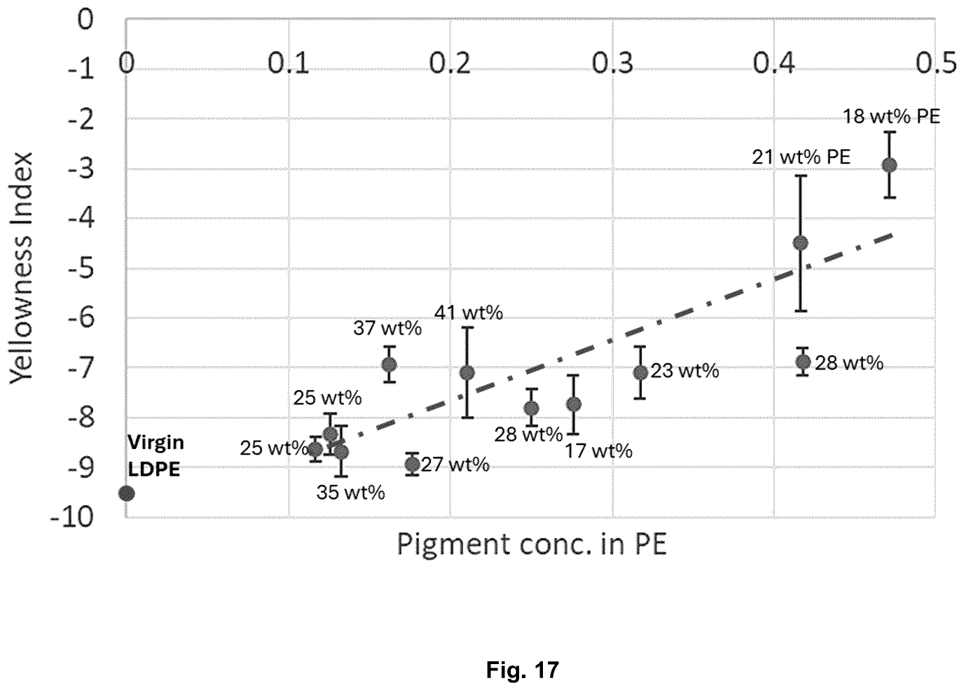

Further investigations take into account pigment concentrations. The pigment level in dried PE was estimated by [(pre-oven mass*conc.)/(post oven mass)]. As shown in Table 7 and FIG. 17, reducing residual solvent largely lowers the pigment level after drying, thus decreasing yellowness, resulting in products even close to virgin PE. Other factors relevant to pigment concentration in the dried product include solubility (i.e., solvent/solid ratio) and decomposition rate of the pigments impacted by temperature and time of the STRAP process. The liquid to solids ratio is roughly proportional to pigment content in dried plastic products. The coefficient of the liquid to solids ratio versus PE Yellowness Index can be obtained.

TABLE 7
Yellowness index of dried products from polymer cakes with different
solid contents and initial pigment concentration in the solution.

| Light abs of | Solution | Pre-oven | Post-oven | % solids of | Yellowness |
|---|---|---|---|---|---|
| solution | Conc. (mg/L) | mass (g) | mass (g) | cake | Index* |
| 0.082 | 0.86 | 2.600 | 1.0670 | 41.04% | −7.09 |
| 0.082 | | 4.916 | 1.0194 | 20.74% | −4.5 |
| 0.082 | | 5.731 | 1.0500 | 18.32% | −2.94 |
| 0.044 | 0.47 | 2.920 | 1.0334 | 35.39% | −8.68 |
| 0.044 | | 3.993 | 1.0627 | 26.61% | −8.94 |
| 0.044 | | 6.216 | 1.0576 | 17.01% | −7.74 |
| 0.057 | 0.60 | 2.940 | 1.0941 | 37.21% | −6.94 |
| 0.029 | 0.31 | 4.294 | 1.0697 | 24.91% | −8.34 |
| 0.067 | 0.71 | 3.7775 | 1.0686 | 28.29% | −7.81 |
| 0.027 | 0.29 | 4.336 | 1.0862 | 25.05% | −8.63 |
| 0.070 | 0.74 | 4.650 | 1.0832 | 23.29% | −7.1 |
| 0.113 | 1.18 | 3.8658 | 1.0973 | 28.38% | −6.87 |

*Yellowness index was measured by Kevin Nelson (Amcor).

### Solvent Cleaning

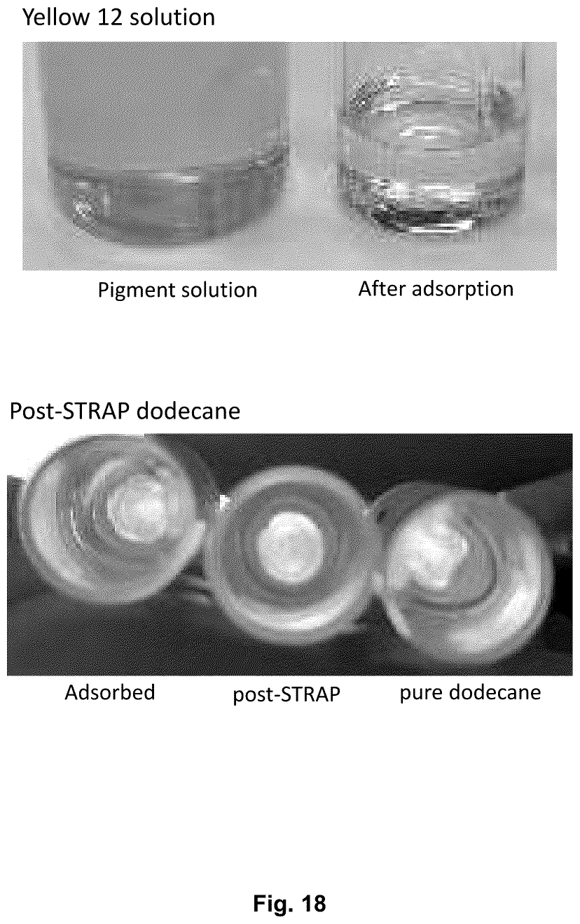

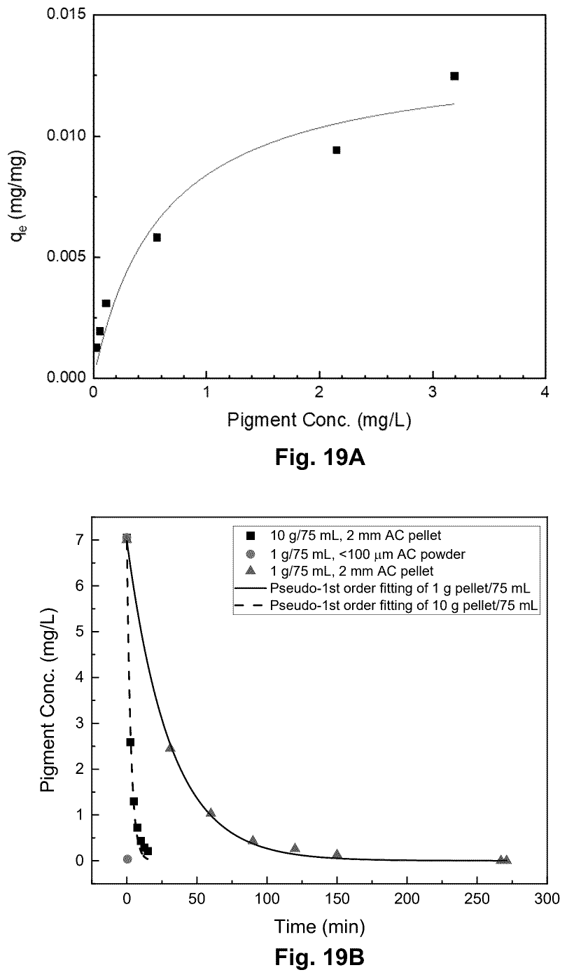

Recycled solvent can be cleaned with adsorbent. For instance, activated carbon can efficiently adsorb the coloring component from post-STRAP solvent. The diameter of activated carbon pellets ranges from 10 μm to 3000 μm for effective color removal. Dissolved pigment (derivative) can be adsorbed by activated carbon (AC) from PY12 solution and post-STRAP dodecanes (FIG. 18). Colored component concentration in STRAP solvents varies with conditions, but is typically about 0.5˜1 mg/L under STRAP condition (determined by UV-Vis calibration). Experimental data show that the AC capacity is >1 g pigment PY12/100 g AC (FIG. 19A). The adsorption kinetics heavily dependent on AC particle size and loading, and the required time for adsorption varies from <30 s to several hours (FIG. 19B).

An adsorption bed can be used to remove colorants and other contaminants from recovered solvent before reusing and avoid colorant accumulation. The adsorption bed comprises:
A packed adsorbent column for removal of colorants, plasticizers, slip agents, additives, and other contaminants;
A porous, cylindrical filter to allow outflow of solvent, but not solid adsorbent particles; and
A backup adsorption column for column shifting and replacement.

The adsorbents include, but are not limited to, activated carbon, silica, alumina, molecular sieves, zeolites, diatomaceous earth, etc.

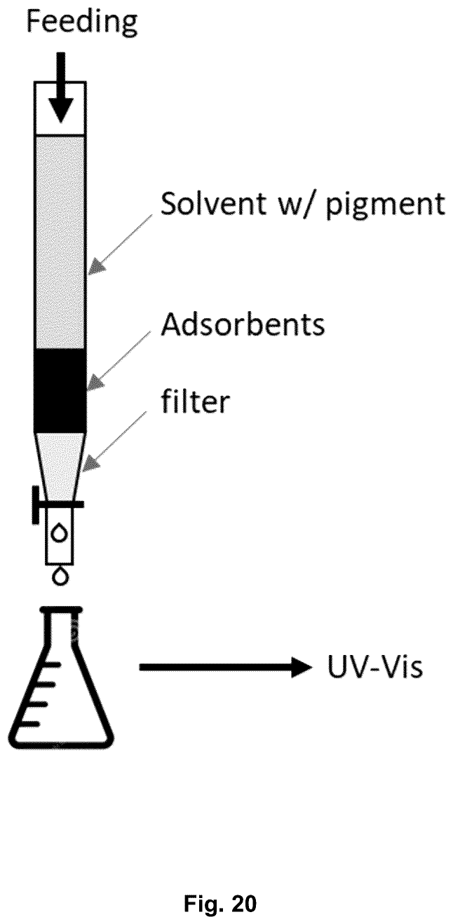

In an exemplary adsorption bed as shown in FIG. 20, the recycled solvent is passed through the adsorption bed. The adsorption bed can treat >800˜900 times of pigment solution (0.5˜1 mg/L) before significant decrease in removal efficiency. Passing 150 mL PY12 toluene solution (7 mg/L, WHSV=100˜150 h⁻¹) through 150 mg AC powders (d=90 μm; d90) resulted in colorless solvent (>95% efficiency). With AC pellets (d˜2 mm), eluent was slightly yellowish. Reducing particle size of AC should help to enhance the adsorption. Actual post-STRAP dodecane has lower (yellow) pigment concentration than the tested solution (0.5˜1 mg/L), so the adsorption bed should serve longer than the test before replacement. Conditions of the adsorption bed can be further optimized, including adjusting the adsorbent types, adsorbent particle sizes, flow rates, etc.

### Colorant Removal From Polymer Solution Via Hot Adsorption

In addition to cleaning recycled solvent, adsorbent can be used to remove colorants from polymer solution before subsequent precipitation step.

The absorbent can be held in an aforementioned packed bed, or

A porous filter bag to allow outflow of polymer solution, but not solid adsorbent particles.

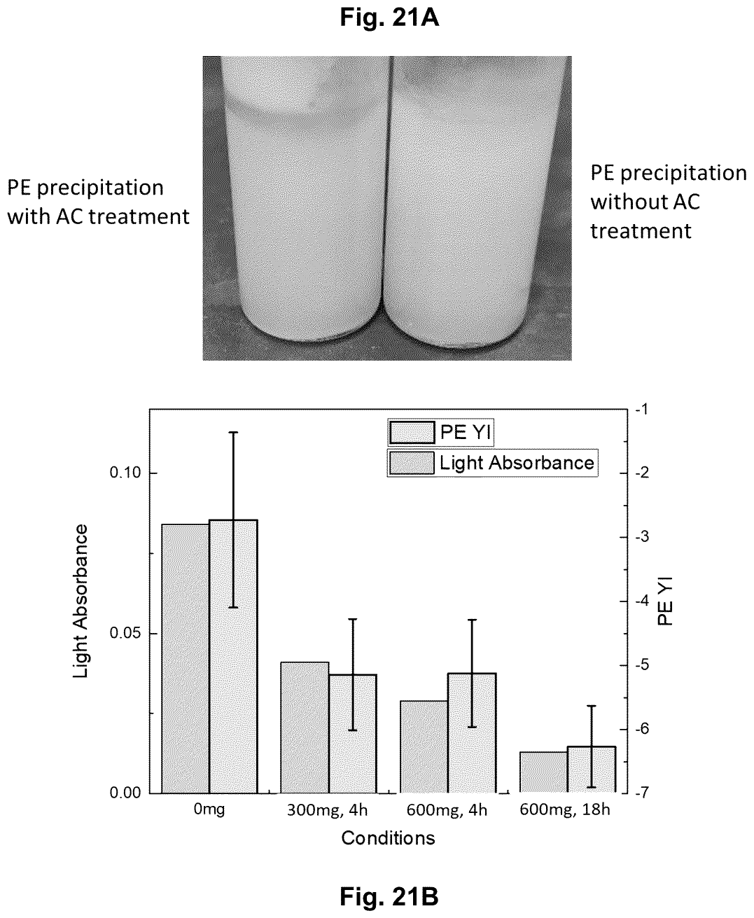

In an exemplary experiment, 36 mL polymer solution (1.2 g LDPE, ˜1 mg/L pigments) in dodecanes was agitated with a filter bag containing 300 mg or 600 mg granular AC (d=2 mm) for 4 and 18 hours at 120° C. Precipitation, filtration and compression were applied afterward with polymer cakes containing 30 wt % PE before vacuum drying. Yellowness Index of vacuum-dried samples was measured and shown in Table 8 and FIG. 21. Hot adsorption with AC exhibited a significant decrease in pigment concentration in polymer solution and Yellowness Index of dried PE. A similar trend to Table 7 between solvent pigment concentration and YI of PE was observed. The adsorption rate and efficiency can be further improved via tuning adsorbent particle size.

TABLE 8
Yellowness index of dried products from polymer
solution treated with hot adsorption.

| | | Solvent Light Absorbance | Yellowness |
|---|---|---|---|
| Adsorbent/mg | Time/h | after Adsorption | Index* |
| 0 | 2 | 0.084 | −2.728 |
| 300 | 4 | 0.041 | −5.142 |
| 300 | 4 | 0.029 | −5.122 |
| 600 | 18 | 0.013 | −6.266 |

*Yellowness index was measured by Kevin Nelson (Amcor)

What is claimed is:

1. A method for recovering a desired polymer with reduced colorant content from colored plastic waste comprising the desired polymer and at least one colorant material, the method comprising:
(a) contacting the plastic waste with a solvent for a time and at a temperature wherein at least a portion of the desired polymer is selectively dissolved in the solvent to yield a polymer solution comprising the desired polymer, wherein the solvent has a solubility for colored components such that maximum light absorbance of the polymer solution is below 0.1 at a wavelength of between 400 and 700 nm using a 10 mm light path;
(b) mechanically separating at least a portion of the polymer solution from undissolved plastic waste; and
(c) precipitating at least a portion of the desired polymer present in the polymer solution to yield precipitated polymer having reduced colorant content.

2. The method of claim 1, further comprising
(d) filtering at least a portion of the precipitated polymer from the solvent to yield filtered, precipitated polymer; and then
(e) drying the filtered, precipitated polymer.

3. The method of claim 1, wherein the plastic waste of step (a) comprises at least one colorant selected from the group consisting of azo pigments, arylide pigments, diarylide pigments, isoindolinone pigments, phthalocyanine pigments, dioxazine pigments, quinacridone pigments, and decomposition products of these pigments.

4. The method of claim 3, wherein the Hansen Solubility Parameter polymer-solvent distance (Rₐ) to polymer interaction radius (R₀) ratio (Rₐ/R₀) of the solvent for the desired polymer is less than about 1.

5. The method of claim 1, wherein the solvent comprises an alkane.

6. The method of claim 5, wherein the alkane is a C₆ to C₁₈ alkane.

7. The method of claim 5, wherein the alkane is a C₆ to C₁₂ alkane.

8. The method of claim 5, wherein the alkane is dodecane.

9. The method of claim 1, wherein step (a) comprises contacting the plastic waste with the solvent at a temperature of from about 20° C. to about 150° C.

10. The method of claim 1, wherein step (a) comprises contacting the plastic waste with the solvent at a solvent-to-plastic ratio of at least 10:1 (w/w).

11. The method of claim 2, wherein step (d) is conducted with a mechanical deliquoring device selected from the group consisting of a filter press, a dewatering screw, a piston press, a vacuum filter, a plate and frame filter, a centrifuge, and a belt filter press.

12. The method of claim 2, wherein step (d) is conducted in a combined precipitator and piston-press device, the device comprising:
a precipitator dimensioned and configured to precipitate at least a portion of the desired polymer from the polymer solution to form a slurry;
a first valve to seal the precipitator during precipitation;
a mechanical piston within the precipitator dimensioned and configured to compresses the slurry after precipitation to yield a compressed polymer cake; and
a filter dimensioned and configured to allow outflow of at least a portion of the solvent, but not the precipitated polymer, during compression.

13. The method of claim 12, wherein the precipitator comprises a vertical, temperature-controlled column.

14. The method of claim 13, wherein the column has a length to diameter ratio of at least 10:1.

15. The method of claim 12, wherein the first valve is a knife edge valve.

16. The method of claim 1, wherein in step (b), at least a portion of the solvent is removed from the undissolved plastic waste by mechanical filtration using a device selected from the group consisting a of piston press, a filter press, a dewatering screw, and a dewatering centrifuge.

17. The method of claim 1, further comprising step (d):
(d) separating at least a portion of the precipitated polymer from the solvent to yield recycled solvent.

18. The method of claim 17, wherein step (d) further comprises passing the recycled solvent through an adsorption bed containing adsorbent material.

19. The method of claim 17, wherein in step (d) the adsorbent material is selected from the group consisting of activated carbon, silica, alumina, molecular sieves, zeolites, and diatomaceous earth.

20. A method for recovering a desired polymer with reduced colorant content from colored plastic waste comprising the desired polymer and at least one colorant material, the method comprising:
(a) contacting the plastic waste with a solvent for a time and at a temperature wherein at least a portion of the desired polymer is selectively dissolved in the solvent to yield a polymer solution comprising the desired polymer, wherein the solvent has a solubility for colored components such that maximum light absorbance of the polymer solution is below 0.1 at a wavelength of between 400 and 700 nm using a 10 mm light path;
(b) mechanically separating at least a portion of the polymer solution from undissolved plastic waste;
(c) passing the dissolved polymer-solvent solution through an adsorbent bed; and
(d) precipitating at least a portion of the desired polymer present in the polymer solution to yield precipitated polymer having reduced colorant content.

21. The method of claim 20, wherein in step (c) the adsorbent material is selected from the group consisting of activated carbon, silica, alumina, molecular sieves, zeolites, and diatomaceous earth.
